(19) United States
(12) Patent Application Publication
(10) Pub. No.: US 2013/0340878 A1
(43) Pub. Date: Dec. 26, 2013

(54) Insulator and manufacturing method thereof

(71) Applicant: Pil-Se LEE, Andong-si (KR)

(72) Inventor: Pil-Se LEE, Andong-si (KR)

(21) Appl. No.: 13/528,797

(22) Filed: Jun. 20, 2012

(51) Int. Cl. H01B 17/58; B32B 1/08

(52) U.S. Cl. CPC H01B 17/58; B32B 1/08
USPC 138/140; 156/242

(57) ABSTRACT

Disclosed therein is an insulator, which includes an inner sheath formed in such a fashion that a binder, is soaked to a glass fiber mat having a multiple layer winding, the insulator comprising: a first reinforced layer accommodating the outer surface of the inner sheath, the first reinforced layer being made of one of flame-resistant polyurethane resin, in which polyol having flame retardant and isocyanate are mixed together, and melamine resin; and a first cover layer for accommodating the outer surface of the first reinforced layer.

### BACKGROUND OF THE INVENTION

1. Field of the Invention

The present invention relates to an insulator and a manufacturing method thereof, and more particularly, to an insulator, which includes an inner sheath formed in such a fashion that a binder is soaked to a glass fiber mat having a multiple layer winding, a reinforced layer formed on the inner sheath, and a cover layer formed on the outer surface of the inner sheath or the reinforced layer, and a manufacturing method of the insulator.

2. Background Art

In general, pipes for heating and cooling systems of power generation plants or petrochemical plants, heating and cooling systems of industrial apparatuses, heating and cooling systems of various manufacturing apparatuses, heating and cooling systems of air-conditioners, and so on require heat insulating materials or cold insulating materials (hereinafter, called an “insulator”) in order to save energies and reduce manufacturing costs by preventing heat exchange with the outside through the pipes.

Such insulators use glass fiber with excellent insulating quality to effectively insulate the surfaces of pipes arranged in power plants. Generally, glass fiber is not burnt due to its excellent insulating quality, has a strong chemical durability since it has a little absorptiveness and hygroscopic property, and has excellent tensile strength and electric insulation.

Such insulators are manufactured through the steps of making a multiple-layer winding of glass fiber mats, and mutually bonding the glass fiber mats by a binder coated on the surfaces of the glass fiber mats.

However, glass fiber, which is a raw material of the insulator, has a melting point of about 700° C., and hence, can sufficiently endure high temperature, but has a problem in that the insulator completed through the binding process cannot keep its heat insulation and cold insulation functions because the binder used when the glass fiber is manufactured into an insulator is easily burnt and is deteriorated in adhesive force at high temperature.

Therefore, in order to keep the heat insulation and cold insulation functions of insulators and use the insulators for heat conserving and insulation, an advanced technology of manufacturing insulators of a good quality is keenly needed.

### SUMMARY OF THE INVENTION

Accordingly, the present invention has been made to solve the above-mentioned problems occurring in the prior arts, and it is an object of the present invention to provide an insulator, which includes an inner sheath formed in such a fashion that a binder is soaked to a glass fiber mat having a multiple layer winding, a reinforced layer formed on the inner sheath, and a cover layer formed on the outer surface of the inner sheath or the reinforced layer, and a manufacturing method of the insulator, thereby enhancing a thermal insulation performance of the insulator by the reinforced layer and making the outward appearance of the insulator beautiful and enhancing water repellant by the cover layer.

To accomplish the above object, according to the present invention, there is provided an insulator, which includes an inner sheath formed in such a fashion that a binder is soaked to a glass fiber mat having a multiple layer winding, the insulator comprising: a first reinforced layer accommodating the outer surface of the inner sheath, the first reinforced layer being made of one of flame-resistant polyurethane resin, in which polyol having flame retardant and isocyanate are mixed together, and melamine resin; and a first cover layer for accommodating the outer surface of the first reinforced layer.

Moreover, there is provided an insulator, which includes an inner sheath formed in such a fashion that a binder is soaked to a glass fiber mat having a multiple layer winding, the insulator comprising: a second reinforced layer grounded to the inner surface of the inner sheath, the second reinforced layer being made of one of flame-resistant polyurethane resin, in which polyol having flame retardant and isocyanate are mixed together, and melamine resin; and a second cover layer for accommodating the outer surface of the inner sheath.

Furthermore, the flame-resistant polyurethane resin forming the first and second reinforced layers (20a, 20b) consists of isocyanate of about 30% to 40% by weight mixed to polyol of about 100% by weight containing flame retardant of about 10% to 20% by weight.

Additionally, the first and second cover layers (30a, 30b) are formed by coating one of groups consisting of Teflon, silver powder, silicon, and aluminum added to glass cloth or by coating one of groups consisting of Teflon, silver powder, silicon, and aluminum added to silica cloth.

In another aspect of the present invention, a manufacturing method of the insulator using the above structure of the insulator includes the steps of: accommodating an inner sheath in a pipe in such a fashion that the outer circumference of the inner sheath previously manufactured is spaced apart from the inner circumference of the pipe, and fixing both sides of the pipe and the inner sheath using guide jigs to keep the state where the outer circumference of the inner sheath is spaced apart from the inner circumference of the pipe; forming an inlet hole vertically perforated to the pipe and injecting one of flame-resistant polyurethane resin and melamine resin into the inlet hole to thereby form a first reinforced layer; separating the pipe and the guide jigs from the first reinforced layer when the first reinforced layer is formed on the outer circumference of the inner sheath by being hardened, and cutting the first reinforced layer according to use purposes; and bonding a first cover layer to the outer circumference of the first reinforced layer using known bonding means.

Moreover, a manufacturing method of the insulator-using the above structure of the insulator includes the steps of: accommodating a pipe in an inner sheath in such a fashion that the outer circumference of the pipe coated with a parting agent is spaced apart from the inner circumference of the inner sheath previously manufactured, and fixing both sides of the pipe and the inner sheath using guide jigs to keep the state where the outer circumference of the pipe is spaced apart from the inner circumference of inner sheath; forming an injection hole vertically perforated to the inner sheath, and injecting one of flame-resistant polyurethane resin and melamine resin into the injection hole to thereby form a second reinforced layer; separating the pipe and the guide jigs from the second reinforced layer when the second reinforced layer is formed on the outer circumference of the inner sheath by being hardened, and cutting the inner sheath according to use purposes; and bonding a second cover layer to the outer circumference of the inner sheath using known bonding means.

Furthermore, a manufacturing method of the insulator using the above structure of the insulator includes the steps of: preparing upper and lower molds having half-shaped cavities, which have the same shape as an insulator to be manufactured when the upper and lower molds are matched, and inserting and fixing the inner sheath previously manufactured into the cavity in such a fashion as to be spaced apart from the cavity of the lower mold; matching the form of the upper mold to the form of the lower mold when the inner sheath is fixed to the lower mold in a state where the cavity formed in the upper and lower molds is spaced apart from the outer circumference of the inner sheath, and injecting one of flame-resistant polyurethane resin and melamine resin into the cavity to thereby form a first reinforced layer; ejecting the first reinforced layer from the upper and lower molds when the first reinforced layer is formed on the outer circumference of the inner sheath by being hardened, and cutting the first reinforced layer according to use purposes; and bonding a first cover layer to the outer circumference of the first reinforced layer using known bonding means.

In addition, a manufacturing method of the insulator using the above structure of the insulator includes the steps of: preparing upper and lower molds having half-shaped cavities, which have the same shape as an insulator to be manufactured when the upper and lower molds are matched, and inserting the inner sheath, which is previously manufactured and has an injection hole, into the cavity of the lower mold, inserting a pipe into the inner sheath, and fixing the pipe and the inner sheath in such a fashion that the outer circumference of the pipe is spaced apart from the inner circumference of the inner sheath; matching the form of the upper mold to the form of the lower mold when the inner sheath and the pipe are fixed to the lower mold, injecting one of flame-resistant polyurethane resin and melamine resin into the cavity to thereby form a second reinforced layer; ejecting the second reinforced layer from the upper and lower molds when the second reinforced layer is formed on the inner circumference of the inner sheath by being hardened, and cutting the inner sheath according to use purposes; and bonding a second cover layer to the outer circumference of the inner sheath using known bonding means.

Because the first or second reinforced layer made of one of flame-resistant polyurethane resin and melamine resin is formed on the inner circumference or the outer circumference of the inner sheath, the insulator provides a double insulation by the inner sheath and the first or second reinforced layer to thereby enhance insulation performance of the insulator.

Moreover, because the first or second reinforced layer is mainly made of one of flame-resistant polyurethane resin and melamine resin, the reinforced layer is more inexpensive than the inner sheath, which is mainly made of glass fiber mat, and the reinforced layer does not need additional process, such as the binding process, and hence, the insulator can reduce manufacturing costs since being easily manufactured and can be easily mass-produced.

Furthermore, because the first or second cover layer 30a, or, 30b having the insulating material coated on the glass cloth or the silica cloth wraps the outer circumference of the insulator, the cover layer can enhance water-repellent performance of the insulator and finish the outward appearance of the insulator beautifully.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing an insulator according to a first preferred embodiment of the present invention;

FIG. 2 is a sectional view showing an insulator according to a second preferred embodiment of the present invention;

FIGS. 3(a) and 3(b) are sectional views showing an insulator according to a third preferred embodiment of the present invention;

FIGS. 4(a) and 4(b) are sectional views showing an insulator according to a fourth preferred embodiment of the present invention;

FIGS. 5(a), 5(b), 5(c) and 5(d) are exemplary views showing manufactured forms of the insulator having a first reinforced layer and a first cover layer according to the first preferred embodiment;

FIGS. 6(a), 6(b), 6(c) and 6(d) are exemplary views showing manufactured forms of the insulator having a second reinforced layer and a second cover layer according to the first preferred embodiment;

FIG. 7 is an exemplary view showing a manufactured form of the insulator having a first reinforced layer and a first cover layer according to the second preferred embodiment; and

FIG. 8 is an exemplary view showing a manufactured form of the insulator having a second reinforced layer and a second cover layer according to the second preferred embodiment.

### DETAILED DESCRIPTION OF THE PREFERRED EMBODIMENT

Reference will be now made in detail to the preferred embodiment of the present invention with reference to the attached drawings.

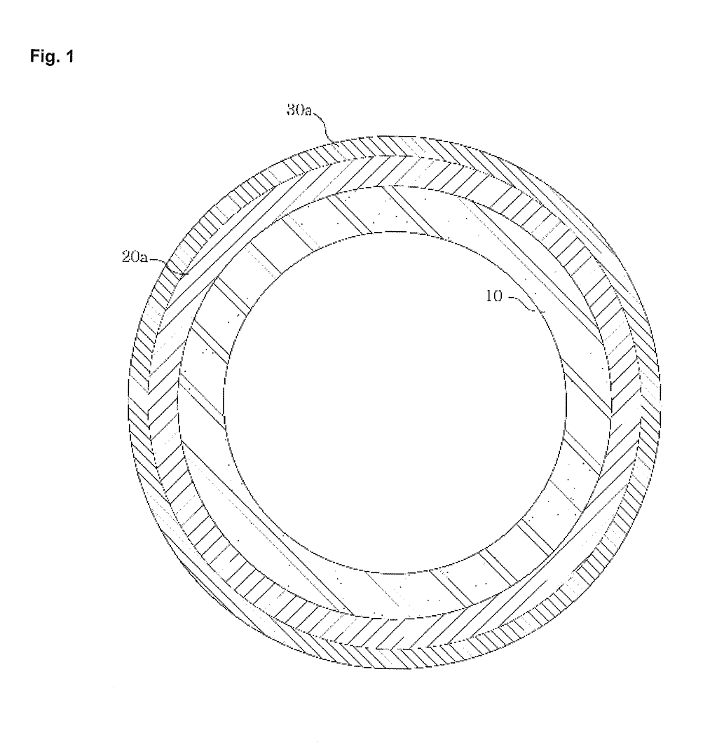

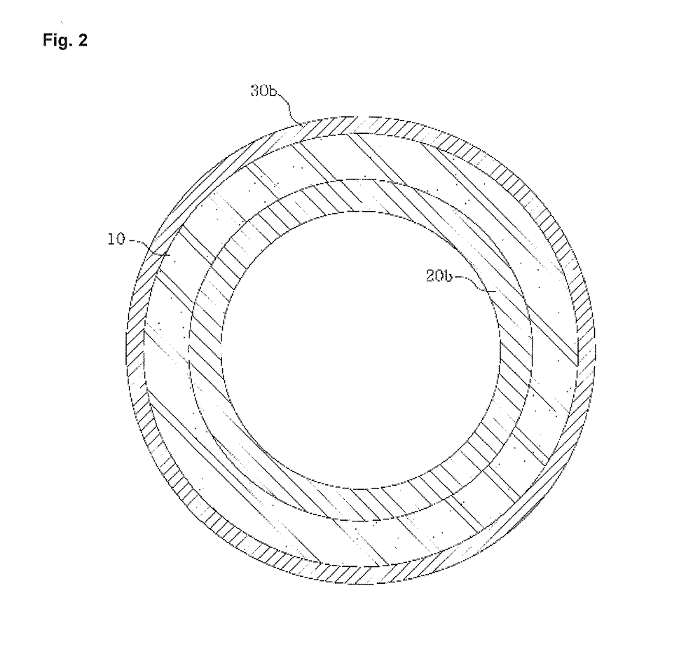

FIG. 1 is a sectional view showing an insulator according to a first preferred embodiment of the present invention, and FIG. 2 is a sectional view showing an insulator according to a second preferred embodiment of the present invention. The insulator according to the present invention is generally mounted on a pipe for heating and cooling systems of power generation plants or petrochemical plants, heating and cooling systems of industrial apparatuses, heating and cooling systems of various manufacturing apparatuses, heating and cooling systems of air-conditioners, and so on in order to prevent heat-exchange with the outside.

For this, the present invention is characterized in that an inner sheath 10, which is formed by soaking a binder to a glass fiber mat having a multiple layer winding, includes a reinforced layer and a cover layer, and in more detail, the reinforced layer and the cover layer are differently formed on the inner sheath 10 according to the first and second embodiments of the present invention.

In the first embodiment of the present invention, the insulator includes a first reinforced layer 20a accommodating the outer surface of the inner sheath 10, wherein the first reinforced layer 20a is made of one of flame-resistant polyurethane resin, in which polyol having flame retardant and isocyanate are mixed together, and melamine resin. Moreover, the insulator further includes a first cover layer 30a for accommodating the outer surface of the first reinforced layer 20a.

In the second embodiment of the present invention, the insulator includes a second reinforced layer 20b grounded on the inner surface of the inner sheath 10, wherein the second reinforced layer 20b is made of one of flame-resistant polyurethane resin, in which polyol having flame retardant and isocyanate are mixed together, and melamine resin. Moreover, the insulator further includes a second cover layer 30b for accommodating the outer surface of the inner sheath 10.

Accordingly, because the first or second reinforced layer 20a or 20b is formed on the inner surface or the outer surface of the inner sheath 10, the insulator can provide a double insulation performance by the inner sheath 10 and the first or second reinforced layer 20a or 20b to thereby enhance the insulation performance thereof.

Furthermore, flame-resistant polyurethane resin or melamine resin, which is a main material for the first or second reinforced layer 20a or 20b, is more inexpensive than the glass fiber mat, which is a main material for the inner sheath 10, and the first and second reinforced layers 20a and 20b do not need additional process, such as the binding process, and hence, they have several advantages in that they can reduce manufacturing costs since being more easily manufactured than the inner sheath 10 and in that they can be easily mass-produced.

In the meantime, as illustrated in the drawings, the insulator according to the present invention has a round section, but may have one of various forms, such as an elbow form, a semicircular form, and others, like the forms of the conventional insulators.

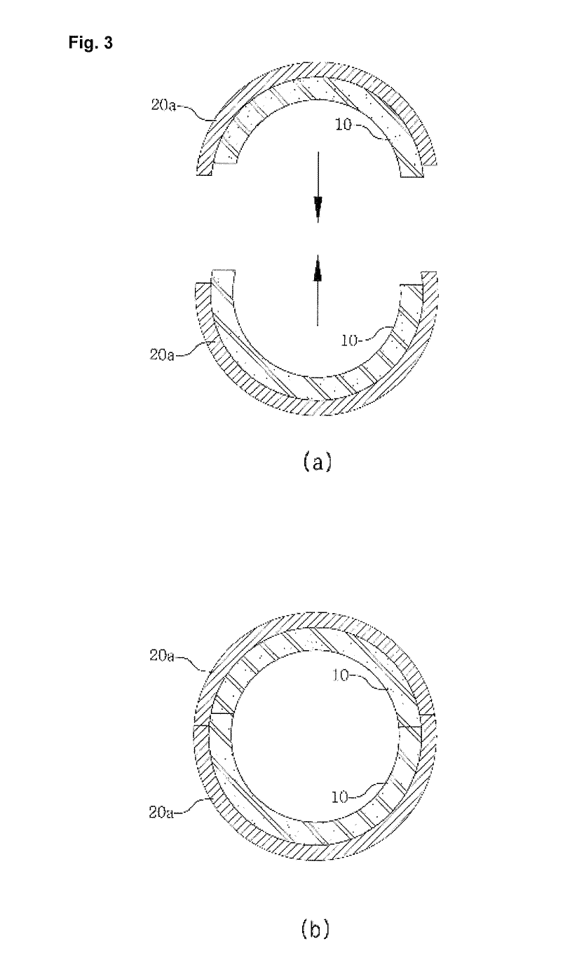

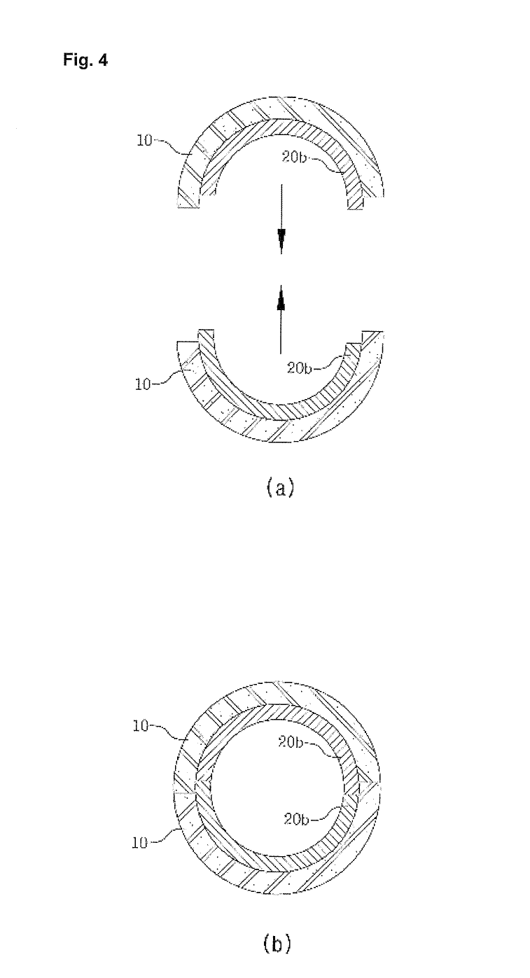

Here, as illustrated in FIGS. 3(a), 3(b), 4(a) and 4(b), the inner sheath 10 and the first or second reinforced layer 20a or 20b, which form the insulator of the present invention, are respectively formed in a circular shape in such a fashion that half-shaped (semicircular-shaped) inner sheaths 10 and half-shaped (semicircular-shaped) first or second reinforced layers 20a or 20b are matched and attached into the circular shape, and in this instance, the attached portions of the inner sheath 10 and the first and second reinforced layers 20a and 20b are not arranged on the same horizontal line to thereby maximize the insulating effect of the insulator.

Here, it is preferable that the flame-resistant polyurethane resin consists of isocyanate of about 30% to 40% by weight mixed to polyol of about 100% by weight containing flame retardant of about 10% to 20% by weight.

Additionally, the reason that polyol of about 100% by weight contains flame retardant of about 10% to 20% by weight is that the insulator lacks flame resistance for lack of the flame retardant content if the flame retardant is less than 10% by weight and that the intrinsic physical property of polyurethane having excellent insulation quality may be transformed if the flame retardant exceeds 20% by weight.

In addition, the reason that polyol of about 100% by weight contains isocyanate of about 30% to 40% by weight is to enhance insulation performance by changing the states of the first and second reinforced layers according to weather conditions when the insulator is constructed since the first and second reinforced layers 20a and 20b can be manufactured in a soft state, a semi-hard state, or a hard state by controlling hardness of the flame-resistant polyurethane resin.

Meanwhile, it is preferable that the first and second cover layers 30a and 30b are formed by coating one of groups consisting of Teflon, silver powder, silicon, and aluminum added to glass cloth (GC) or by coating one of groups consisting of Teflon, silver powder, silicon, and aluminum added to silica cloth.

Accordingly, the first or second cover layer 30a or 30b having the insulating material coated on the glass cloth or the silica cloth wraps the outer surface of the insulator to thereby enhance water-repellent performance of the insulator and finish the outward appearance of the insulator beautifully.

Moreover, thickness of the first and second cover layers 30a and 30b is varied in proportion to the whole thickness of the insulator, but it is preferable that the thickness of the first and second cover layers 30a and 30b is about 0.2 mm to 2.8 mm in order to enhance the water-repellent performance, and in case of the first and second cover layers 30a and 30b coated with aluminum with high intensity, it is preferable that the thickness of the first and second cover layers 30a and 30b is about 20 μm to 100 μm.

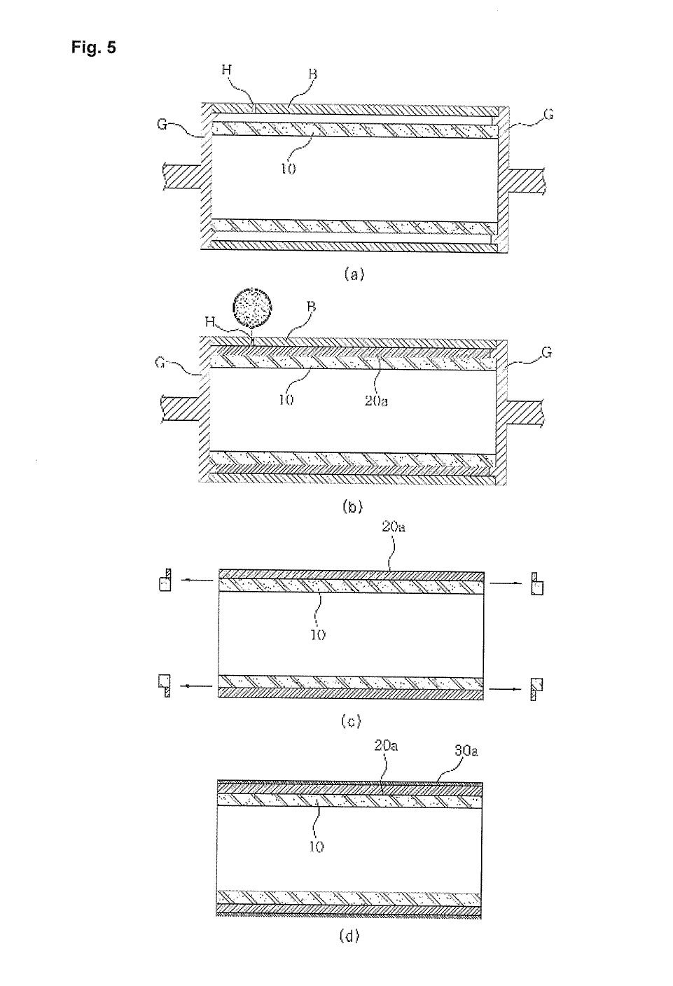

Now, manufacturing methods of the insulators according to the first and second embodiments using the above structures as shown in FIGS. 5 to 8 will be described.

First, as illustrated in FIGS. 5(a) to 5(d), the manufacturing method of the insulator having the first reinforced layer 20a and the first cover layer 30a according to the first embodiment will be described.

The manufacturing method of the insulator includes:

a first step of accommodating the inner sheath 10 in a pipe (B) in such a fashion that the outer circumference of the inner sheath 10 previously manufactured is spaced apart from the inner circumference of the pipe (B), and fixing both sides of the pipe (B) and the inner sheath 10 using guide jigs (G) to keep the state where the outer circumference of the inner sheath 10 is spaced apart from the inner circumference of the pipe (B);

a second step of forming an inlet hole (H) vertically perforated to the pipe (B) in such a way as to be connected to a portion that the outer circumference of the inner sheath 10 is spaced apart from the inner circumference of the pipe (B), and injecting one of flame-resistant polyurethane resin and melamine resin into the inlet hole (H) to thereby form the first reinforced layer 20a;

a third step of separating the pipe (B) and the guide jigs (G) from the first reinforced layer 20a when the first reinforced layer 20a is formed on the outer circumference of the inner sheath 10 by being coagulated and hardened, and cutting the first reinforced layer 20a according to use purposes; and

a fourth step of bonding the first cover layer 30a to the outer circumference of the first reinforced layer 20a using known bonding means.

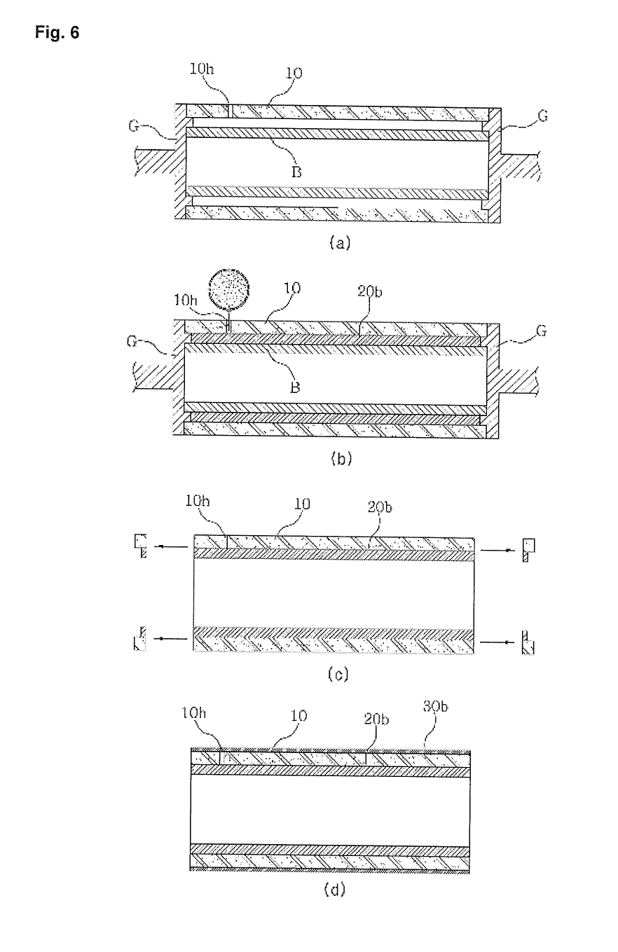

As illustrated in FIGS. 6(a) to 6(d), the manufacturing method of the insulator having the second reinforced layer 20b and the second cover layer 30b according to the first embodiment will be described.

The manufacturing method of the insulator includes:

a first step of accommodating the pipe (B) in the inner sheath 10 in such a fashion that the outer circumference of the pipe (B) coated with a parting agent is spaced apart from the inner circumference of the inner sheath 10 previously manufactured, and fixing both sides of the pipe (B) and the inner sheath 10 using guide jigs (G) to keep the state where the outer circumference of the pipe (B) is spaced apart from the inner circumference of inner sheath 10;

a second step of forming an injection hole 10h vertically perforated to the inner sheath 10 in such a way as to be connected to the portion that the outer circumference of the pipe (B) is spaced apart from the inner circumference of the inner sheath 10, and injecting one of flame-resistant polyurethane resin and melamine resin into the injection hole 10h to thereby form the second reinforced layer 20b;

a third step of separating the pipe (B) and the guide jigs (G) from the second reinforced layer 20b when the second reinforced layer 20b is formed on the outer circumference of the inner sheath 10 by being coagulated and hardened, and cutting the inner sheath 10 according to use purposes; and

a fourth step of bonding the second cover layer 30b to the outer circumference of the inner sheath 10 using known bonding means.

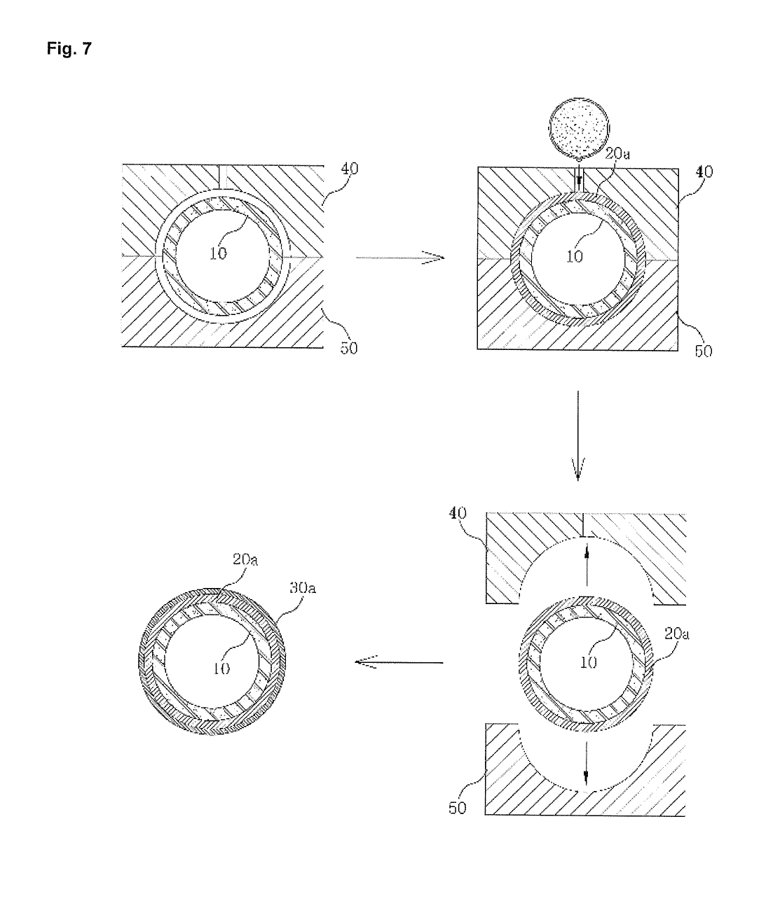

Furthermore, as illustrated in FIG. 7, the manufacturing method of the insulator having the first reinforced layer 20a and the first cover layer 30a according to the second embodiment of the present invention will be described.

The manufacturing method of the insulator includes:

a first step of preparing upper and lower molds 40 and 50 having half-shaped cavities, which have the same shape as an insulator to be manufactured when the upper and lower molds 40 and 50 are matched, and inserting and fixing the inner sheath 10 previously manufactured into the cavity in such a fashion as to be spaced apart from the cavity of the lower mold 50;

a second step of matching the form of the upper mold 40 to the form of the lower mold 50 when the inner sheath 10 is fixed to the lower mold by the first step in a state where the cavity formed in the upper and lower molds 40 and 50 is spaced apart from the outer circumference of the inner sheath 10, and injecting one of flame-resistant polyurethane resin and melamine resin into the cavity to thereby form the first reinforced layer 20a;

a third step of ejecting the first reinforced layer 20a from the upper and lower molds 40 and 50 when the first reinforced layer 20a is formed on the outer circumference of the inner sheath 10 by being coagulated and hardened, and cutting the first reinforced layer 20a according to use purposes; and

a fourth step of bonding a first cover layer 30a to the outer circumference of the first reinforced layer 20a using known bonding means.

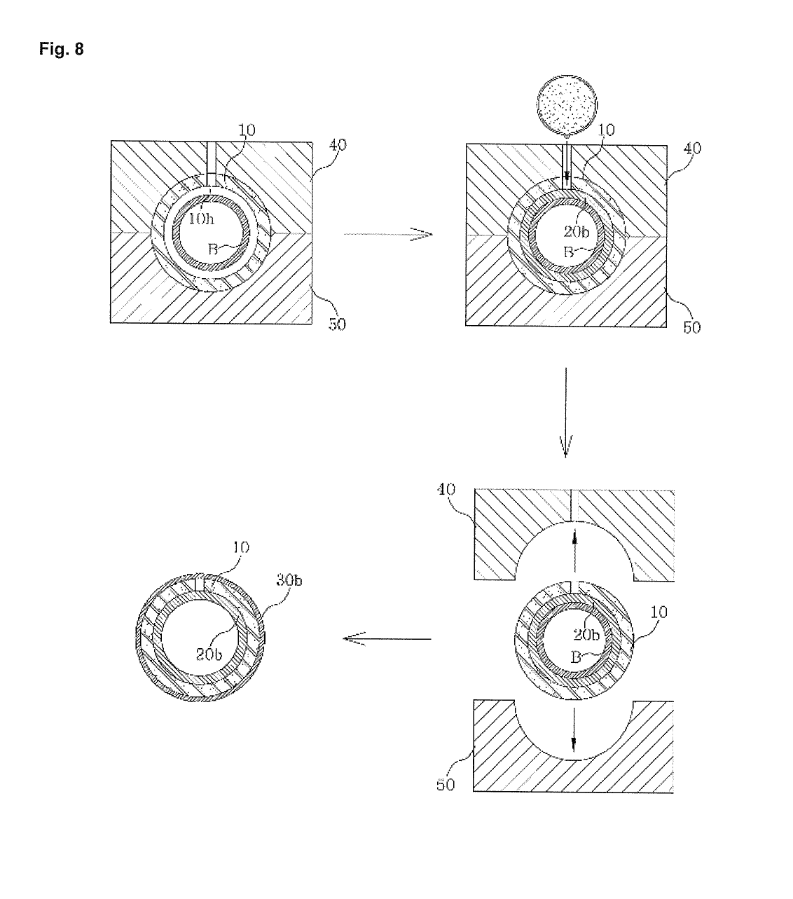

As illustrated in FIG. 8, the manufacturing method of the insulator having the second reinforced layer 20b and the second cover layer 30b according to the second embodiment of the present invention will be described.

The manufacturing method of the insulator includes:

a first step of preparing upper and lower molds 40 and 50 having half-shaped cavities, which have the same shape as an insulator to be manufactured when the upper and lower molds 40 and 50 are matched, and inserting the inner sheath 10 previously manufactured and having an injection hole 10h, inserting the pipe (B) into the inner sheath 10, and fixing the pipe (B) and the inner sheath 10 in such a fashion that the outer circumference of the pipe (B0 is spaced apart from the inner circumference of the inner sheath 10;

a second step of matching the form of the upper mold 40 to the form of the lower mold 50 when the inner sheath 10 and the pipe (B) are fixed to the lower mold 50 by the first step, injecting one of flame-resistant polyurethane resin and melamine resin into the cavity to thereby form the second reinforced layer 20b at the spaced portion between the outer circumference of the pipe (B) and the inner circumference of the inner sheath 10 by the injection hole 10h formed in the inner sheath 10;

a third step of ejecting the second reinforced layer 20b from the upper and lower molds 40 and 50 when the second reinforced layer 20b is formed at the spaced portion between the outer circumference of the pipe (B) and the inner circumference of the inner sheath 10 by being coagulated and hardened, and cutting the inner sheath 10 according to use purposes; and

a fourth step of bonding the second cover layer 30b to the outer circumference of the inner sheath 10 using known bonding means.

1. An insulator, which includes an inner sheath formed in such a fashion that a binder is soaked to a glass fiber mat having a multiple layer winding, the insulator comprising:
a first reinforced layer (20a) accommodating the outer surface of the inner sheath (10), the first reinforced layer (20a) being made of one of flame-resistant polyurethane resin, in which polyol having flame retardant and isocyanate are mixed together, and melamine resin; and
a first cover layer (30a) for accommodating the outer surface of the first reinforced layer (20a).

2. An insulator, which includes an inner-sheath formed in such a fashion that a binder is soaked to a glass fiber mat having a multiple layer winding, the insulator comprising:
a second reinforced layer (20b) grounded to the inner surface of the inner sheath (10), the second reinforced layer (20b) being made of one of flame-resistant polyurethane resin, in which polyol having flame retardant and isocyanate are mixed together, and melamine resin; and
a second cover layer (30b) for accommodating the outer surface of the inner sheath (10).

3. The insulator according to claim 1, wherein the inner sheath (10) and the first or second reinforced layer (20a, 20b) are respectively formed in a semi-circular shape in such a fashion that half-shaped (semicircular-shaped) inner sheaths (10) and half-shaped (semicircular-shaped) first or second reinforced layers (20a, 20b) are matched and attached into the circular shape, and the attached portions of the inner sheath (10) and the first or second reinforced layers (20a, 20b) are not arranged on the same horizontal line.

4. The insulator according to claim 1, wherein the flame-resistant polyurethane resin forming the first and second reinforced layers (20a, 20b) consists of isocyanate of about 30% to 40% by weight mixed to polyol of about 100% by weight containing flame retardant of about 10% to 20% by weight.

5. The insulator according to claim 1, wherein the first and second cover layers (30a, 30b) are formed by coating one of groups consisting of Teflon, silver powder, silicon, and aluminum added to glass cloth or by coating one of groups consisting of Teflon, silver powder, silicon, and aluminum added to silica cloth.

6. A manufacturing method of the insulator according to claim 1, wherein the manufacturing method of the insulator comprises the steps of:
accommodating an inner sheath (10) in a pipe (B) in such a fashion that the outer circumference of the inner sheath (10) previously manufactured is spaced apart from the inner circumference of the pipe (B), and fixing both sides of the pipe (B) and the inner sheath (10) using guide jigs (G) to keep the state where the outer circumference of the inner sheath (10) is spaced apart from the inner circumference of the pipe (B);
forming an inlet hole (H) vertically perforated to the pipe (B) and injecting one of flame-resistant polyurethane resin and melamine resin into the inlet hole (H) to thereby form a first reinforced layer (20a);
separating the pipe (B) and the guide jigs (G) from the first reinforced layer (20a) when the first reinforced layer (20a) is formed on the outer circumference of the inner sheath (10) by being hardened, and cutting the first reinforced layer (20a) according to use purposes; and
bonding a first cover layer (30a) to the outer circumference of the first reinforced layer (20a) using known bonding means.

7. A manufacturing method of the insulator according to claim 1, wherein the manufacturing method of the insulator comprises the steps of:
accommodating a pipe (B) in an inner sheath (10) in such a fashion that the outer circumference of the pipe (B) coated with a parting agent is spaced apart from the inner circumference of the inner sheath (10) previously manufactured, and fixing both sides of the pipe (B) and the inner sheath (10) using guide jigs (G) to keep the state where the outer circumference of the pipe (B) is spaced apart from the inner circumference of inner sheath (10);
forming an injection hole (10h) vertically perforated to the inner sheath (10), and injecting one of flame-resistant polyurethane resin and melamine resin into the injection hole (10h) to thereby form a second reinforced layer (20b);
separating the pipe (B) and the guide jigs (G) from the second reinforced layer (20b) when the second reinforced layer (20b) is formed on the outer circumference of the inner sheath (10) by being hardened, and cutting the inner sheath (10) according to use purposes; and
bonding a second cover layer (30b) to the outer circumference of the inner sheath (10) using known bonding means.

8. A manufacturing method of the insulator according to claim 1, wherein the manufacturing method of the insulator comprises the steps of:
preparing upper and lower molds (40, 50) having half-shaped cavities, which have the same shape as an insulator to be manufactured when the upper and lower molds (40, 50) are matched, and inserting and fixing the inner sheath (10) previously manufactured into the cavity in such a fashion as to be spaced apart from the cavity of the lower mold (50);
matching the form of the upper mold (40) to the form of the lower mold (50) when the inner sheath (10) is fixed to the lower mold (50) in a state where the cavity formed in the upper and lower molds (40, 50) is spaced apart from the outer circumference of the inner-sheath (10), and injecting one of flame-resistant polyurethane resin and melamine resin into the cavity to thereby form a first reinforced layer (20a);
ejecting the first reinforced layer (20a) from the upper and lower molds (40, 50) when the first reinforced layer (20a) is formed on the outer circumference of the inner sheath (10) by being hardened, and cutting the first reinforced layer (20a) according to use purposes; and
bonding a first cover layer (30a) to the outer circumference of the first reinforced layer (20a) using known bonding means.

9. A manufacturing method of the insulator according to claim 1, wherein the manufacturing method of the insulator comprises the steps of:
preparing upper and lower molds (40, 50) having half-shaped cavities, which have the same shape as an insulator to be manufactured when the upper and lower molds (40, 50) are matced, and inserting the inner sheath (10), which is previously manufactured and has an injection hole (10h), into the cavity of the lower mold (50), inserting a pipe (B) into the inner sheath (10), and fixing the pipe (B) and the inner sheath (10) in such a fashion that the outer circumference of the pipe (B) is spaced apart from the inner circumference of the inner sheath (10);
matching the form of the upper mold (40) to the form of the lower mold (50) when the inner sheath (10) and the pipe (B) are fixed to the lower mold (50), injecting one of flame-resistant polyurethane resin and melamine resin into the cavity to thereby form a second reinforced layer (20b);
ejecting the second reinforced layer (20b) from the upper and lower molds (40, 50) when the second reinforced layer (20b) is formed on the inner circumference of the inner sheath (10) by being hardened, and cutting the inner sheath (10) according to use purposes; and
bonding a second cover layer (30b) to the outer circumference of the inner sheath (10) using known bonding means.

10. The insulator according to claim 2, wherein the inner sheath (10) and the first or second reinforced layer (20a, 20b) are respectively formed in a semi-circular shape in such a fashion that half-shaped (semicircular-shaped) inner sheaths (10) and half-shaped (semicircular-shaped) first or second reinforced layers (20a, 20b) are matched and attached into the circular shape, and the attached portions of the inner sheath (10) and the first or second reinforced layers (20a, 20b) are not arranged on the same horizontal line.

11. The insulator according to claim 2, wherein the flame-resistant polyurethane resin forming the first and second reinforced layers (20a, 20b) consists of isocyanate of about 30% to 40% by weight mixed to polyol of about 100% by weight containing flame retardant of about 10% to 20% by weight.

12. The insulator according to claim 2, wherein the first and second cover layers (30a, 30b) are formed by coating one of groups consisting of Teflon, silver powder, silicon, and aluminum added to glass cloth or by coating one of groups consisting of Teflon, silver powder, silicon, and aluminum added to silica cloth.

13. A manufacturing method of the insulator according to claim 2, wherein the manufacturing method of the insulator comprises the steps of:
accommodating an inner sheath (10) in a pipe (B) in such a fashion that the outer circumference of the inner sheath (10) previously manufactured is spaced apart from the inner circumference of the pipe (B), and fixing both sides of the pipe (B) and the inner sheath (10) using guide jigs (G) to keep the state where the outer circumference of the inner sheath (10) is spaced apart from the inner circumference of the pipe (B);
forming an inlet hole (H) vertically perforated to the pipe (B) and injecting one of flame-resistant polyurethane resin and melamine resin into the inlet hole (H) to thereby form a first reinforced layer (20a);
separating the pipe (B) and the guide jigs (G) from the first reinforced layer (20a) when the first reinforced layer (20a) is formed on the outer circumference of the inner sheath (10) by being hardened, and cutting the first reinforced layer (20a) according to use purposes; and
bonding a first cover layer (30a) to the outer circumference of the first reinforced layer (20a) using known bonding means.

14. A manufacturing method of the insulator according to claim 2, wherein the manufacturing method of the insulator comprises the steps of:
accommodating a pipe (B) in an inner sheath (10) in such a fashion that the outer circumference of the pipe (B) coated with a parting agent is spaced apart from the inner circumference of the inner sheath (10) previously manufactured, and fixing both sides of the pipe (B) and the inner sheath (10) using guide jigs (G) to keep the state where the outer circumference of the pipe (B) is spaced apart from the inner circumference of inner sheath (10);
forming an injection hole (10h) vertically perforated to the inner sheath (10), and injecting one of flame-resistant polyurethane resin and melamine resin into the injection hole (10h) to thereby form a second reinforced layer (20b);
separating the pipe (B) and the guide jigs (G) from the second reinforced layer (20b) when the second reinforced layer (20b) is formed on the outer circumference of the inner sheath (10) by being hardened, and cutting the inner sheath (10) according to use purposes; and
bonding a second cover layer (30b) to the outer circumference of the inner sheath (10) using known bonding means.

15. A manufacturing method of the insulator according to claim 2, wherein the manufacturing method of the insulator comprises the steps of:
preparing upper and lower molds (40, 50) having half-shaped cavities, which have the same shape as an insulator to be manufactured when the upper and lower molds (40, 50) are matched, and inserting and fixing the inner sheath (10) previously manufactured into the cavity in such a fashion as to be spaced apart from the cavity of the lower mold (50);
matching the form of the upper mold (40) to the form of the lower mold (50) when the inner sheath (10) is fixed to the lower mold (50) in a state where the cavity formed in the upper and lower molds (40, 50) is spaced apart from the outer circumference of the inner sheath (10), and injecting one of flame-resistant polyurethane resin and melamine resin into the cavity to thereby form a first reinforced layer (20a);
ejecting the first reinforced layer (20a) from the upper and lower molds (40, 50) when the first reinforced layer (20a) is formed on the outer circumference of the inner sheath (10) by being hardened, and cutting the first reinforced layer (20a) according to use purposes; and
bonding a first cover layer (30a) to the outer circumference of the first reinforced layer (20a) using known bonding means.

16. A manufacturing method of the insulator according to claim 2, wherein the manufacturing method of the insulator comprises the steps of:
preparing upper and lower molds (40, 50) having half-shaped cavities, which have the same shape as an insulator to be manufactured when the upper and lower molds (40, 50) are matched, and inserting the inner sheath (10), which is previously manufactured and has an injection hole (10h), into the cavity of the lower mold (50), inserting a pipe (B) into the inner sheath (10), and fixing the pipe (B) and the inner sheath (10) in such a fashion that the outer circumference of the pipe (B) is spaced apart from the inner circumference of the inner sheath (10);
matching the form of the upper mold (40) to the form of the Lower mold (50) when the inner sheath (10) and the pipe (B) are fixed to the lower mold (50), injecting one of flame-resistant polyurethane resin and melamine resin into the cavity to thereby form a second reinforced layer (20b);
ejecting the second reinforced layer (20b) from the upper and lower molds (40, 50) when the second reinforced layer (20b) is formed on the inner circumference of the inner sheath (10) by being hardened, and cutting the inner sheath (10) according to use purposes; and
bonding a second cover layer (30b) to the outer circumference of the inner sheath (10) using known bonding means.
